(19) United States
(12) Patent Application Publication
(10) Pub. No.: US 2015/0264229 A1
(43) Pub. Date: Sep. 17, 2015

(54) MODULAR CAMERA SYSTEM

(71) Applicant: Wilcox Industries Corp., Newington, NH (US)

(72) Inventors: James W. Teetzel, Portsmouth, NH (US); Gary M. Lemire, Lee, NH (US)

(21) Appl. No.: 14/656,903

(22) Filed: Mar. 13, 2015

Related U.S. Application Data
(60) Provisional application No. 61/953,150, filed on Mar. 14, 2014.

(51) Int. Cl. H04N 5/225

(52) U.S. Cl. CPC H04N 5/2252; H04N 5/2254

(57) ABSTRACT

A modular camera system includes a camera body having a housing, which has a rearward facing end, a forward facing end opposite the rearward facing end, and a plurality of mounting surfaces extending between the rearward facing end and the forward facing end. A photosensor and lens mount are mounted on the forward facing end of the camera body, the lens mount for removably attaching a lens assembly configured to direct photons from an area outside the camera body to the photosensor. A processor within the camera body converts a signal from the photosensor to a video signal. A display assembly removably attachable to the rearward facing end of the camera body includes a display screen configured to display the video signal received from the processor in human viewable form. Each of the plurality of mounting surfaces includes one or more fastener elements for removably and interchangeably attaching an accessory module.

### CROSS-REFERENCE TO RELATED APPLICATION(S)

This application claims the benefit of U.S. Provisional Application No. 61/953,150 filed Mar. 14, 2014. The aforementioned application is incorporated herein by reference in its entirety.

### BACKGROUND

The present invention relates to a camera system and, in particular, to a modular camera system for handheld, helmet mounted, and weapon mounted use.

### SUMMARY

A modular camera system includes a camera body having a housing, the housing having a rearward facing end, a forward facing end opposite the rearward facing end, and a plurality of mounting surfaces extending between the rearward facing end and the forward facing end. A photosensor and lens mount are mounted on the forward facing end of the camera body. The lens mount allows for removably attaching a lens assembly configured to direct photons from an area outside the camera body to the photosensor. A processor within the camera body is operably coupled to the photosensor and configured to convert a signal received from the photosensor to a video signal. A display assembly is configured to be removably attached to the rearward facing end of the camera body, the display assembly including a display screen configured to display the video signal received from the processor in human viewable form. Each of the plurality of mounting surfaces includes one or more fastener elements for removably and interchangeably attaching an accessory module.

### BRIEF DESCRIPTION OF THE DRAWING

The invention may take form in various components and arrangements of components, and in various steps and arrangements of steps. The drawings are only for purposes of illustrating preferred embodiments and are not to be construed as limiting the invention.

FIG. 1 is an exploded view of an exemplary embodiment camera system configured for helmet mounting.

FIG. 2 is a perspective view of the system appearing in FIG. 1 taken generally from the front and the right side.

FIG. 3 is a perspective view of the system appearing in FIG. 1 taken generally from the front and the left side.

FIG. 4 is an enlarged perspective view of an exemplary embodiment camera system configured for hand held use taken generally from the front and right side.

FIG. 5 is an enlarged perspective view of the system appearing in

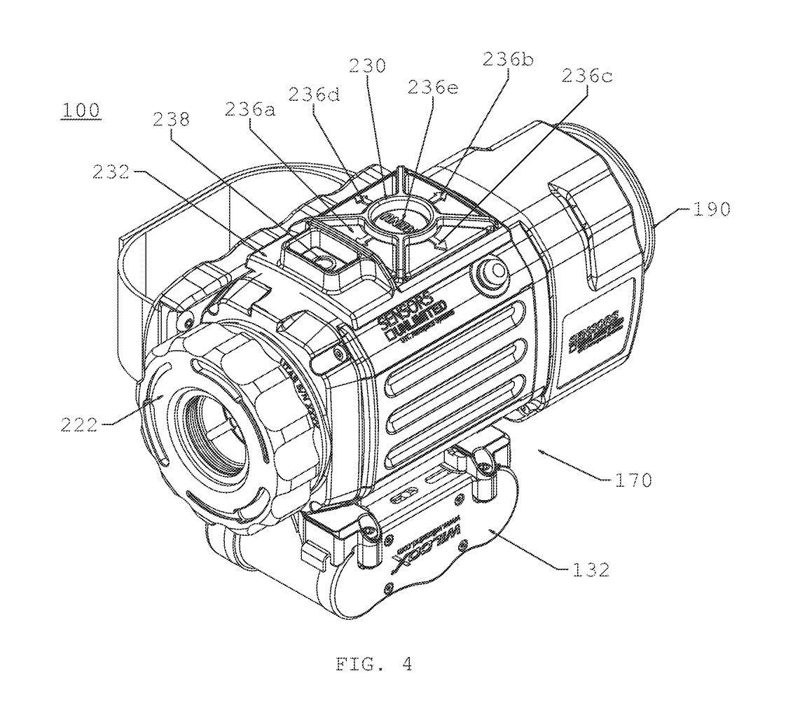

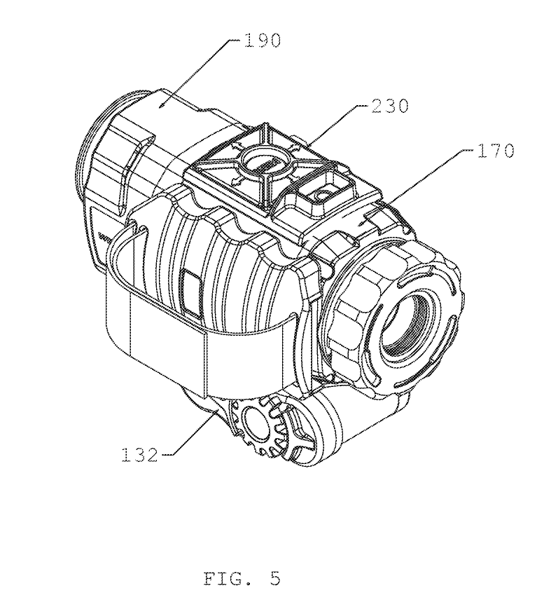

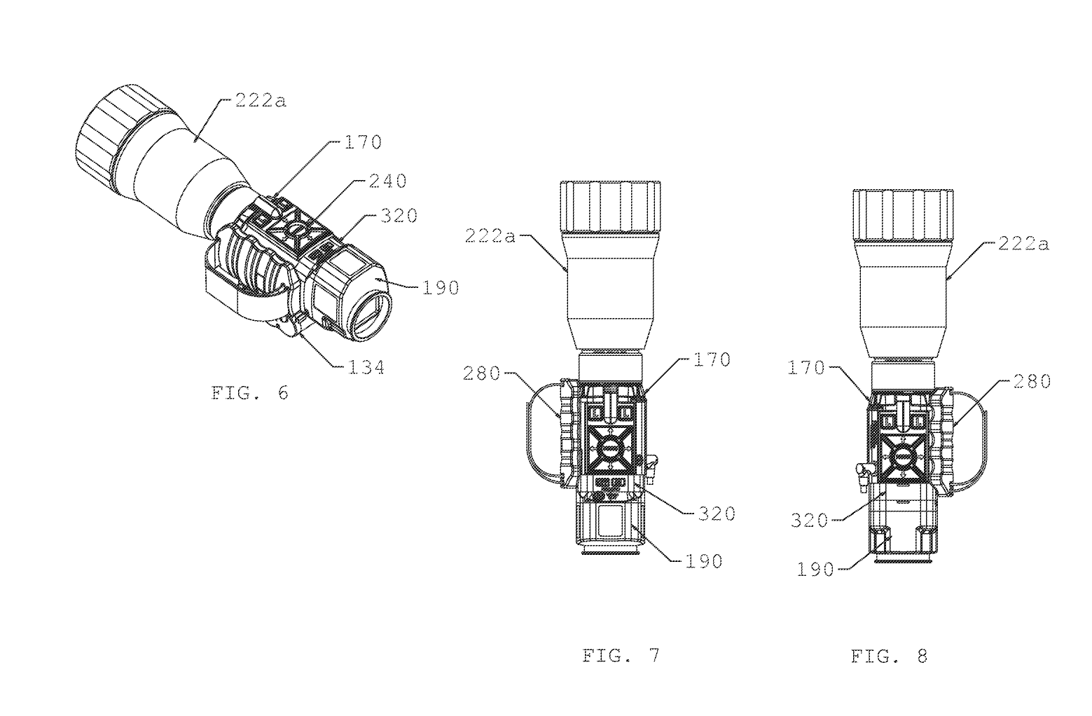

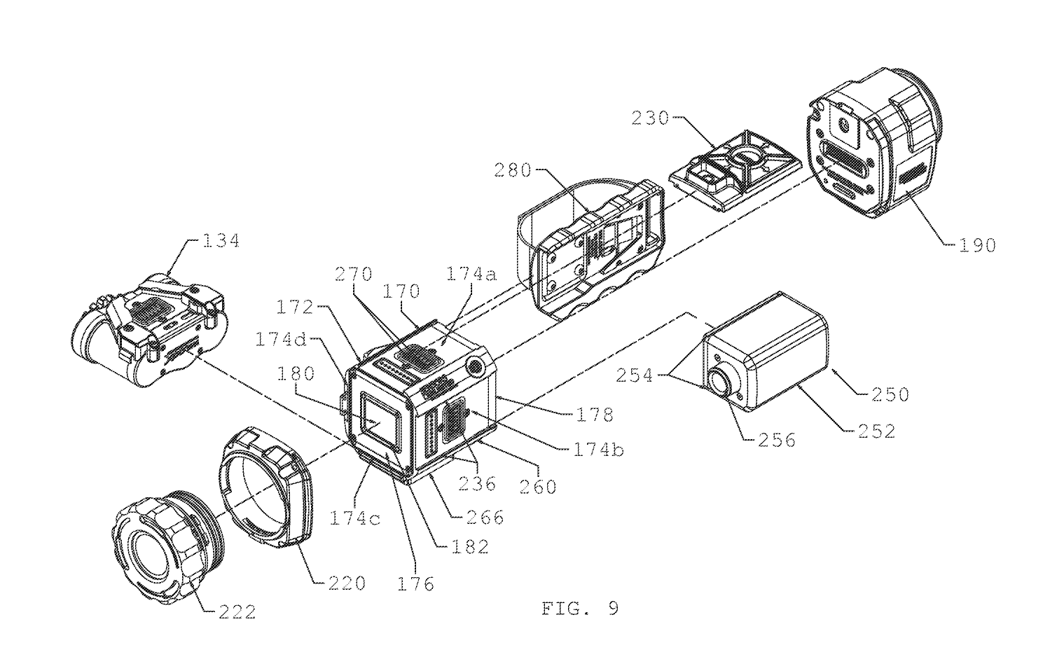

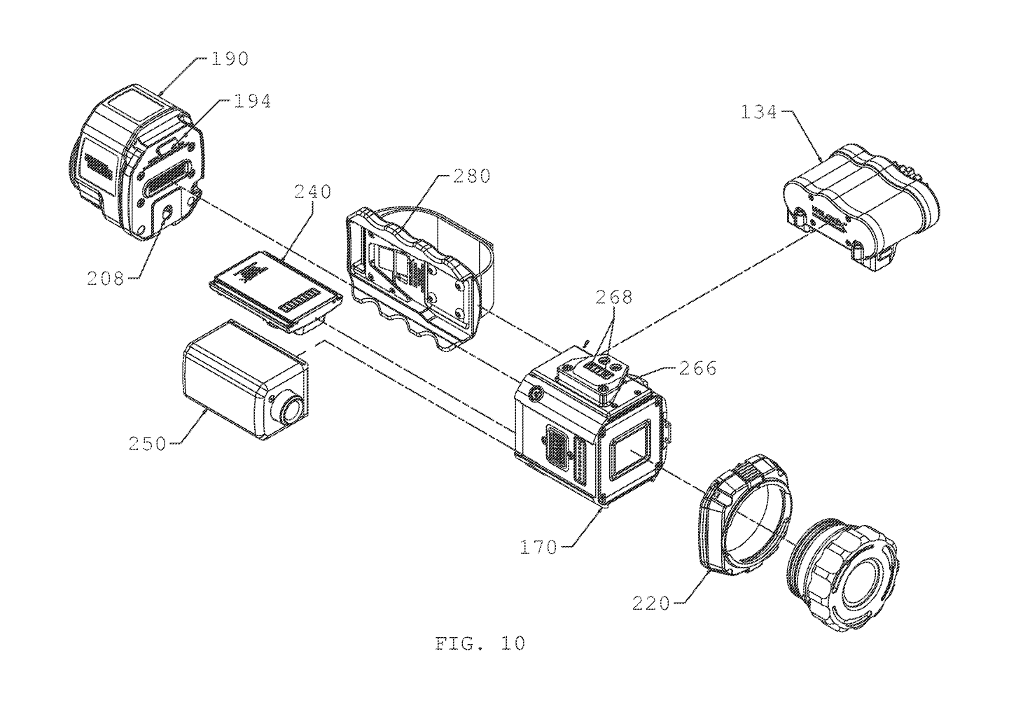

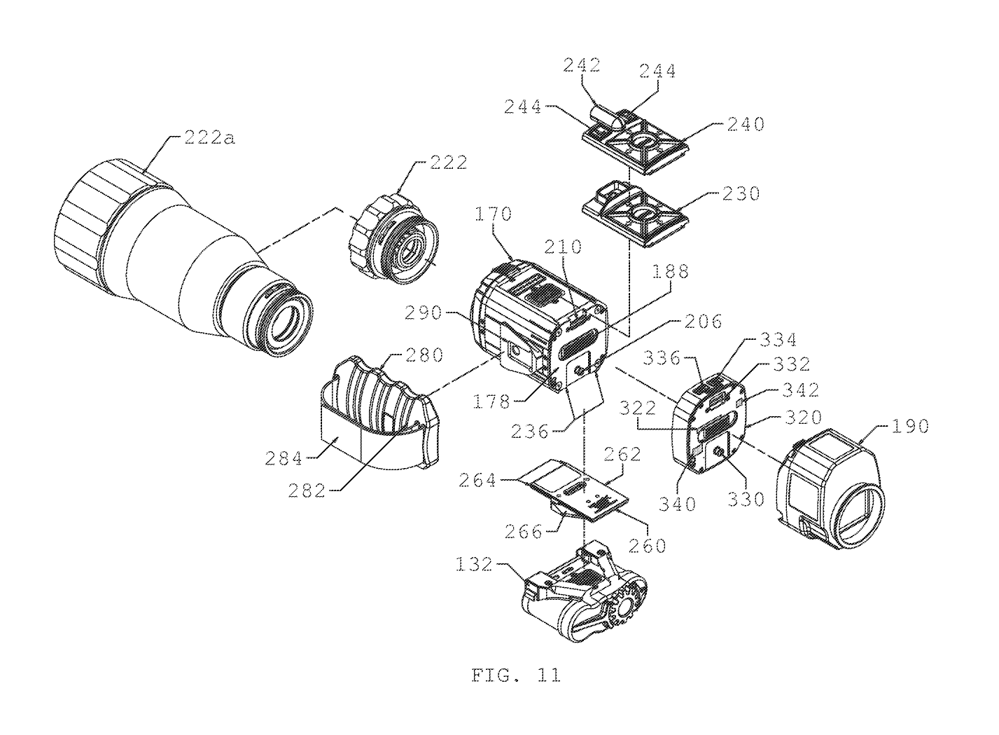

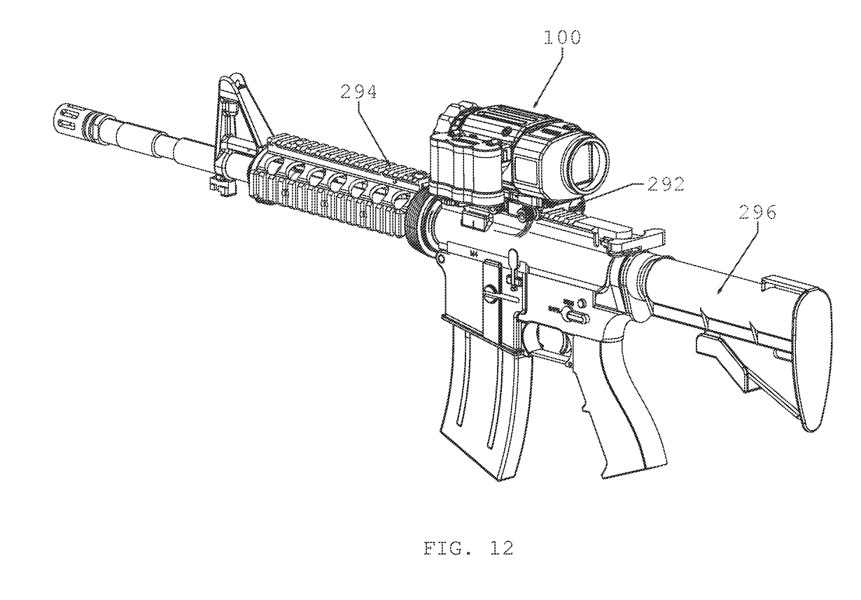

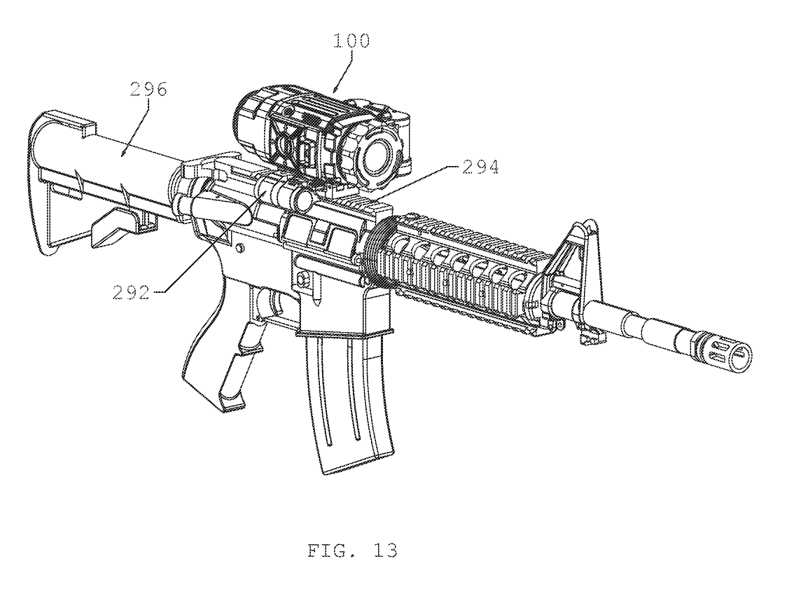

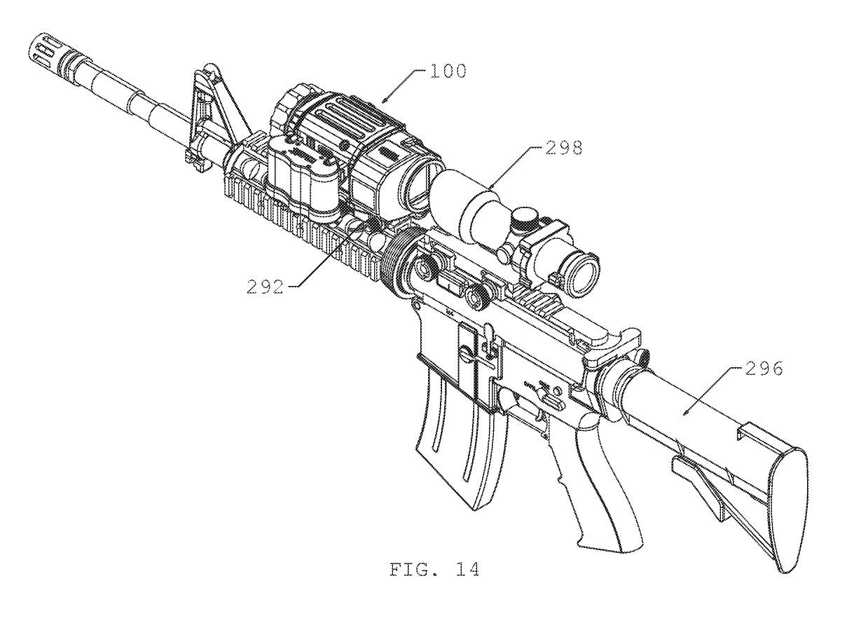

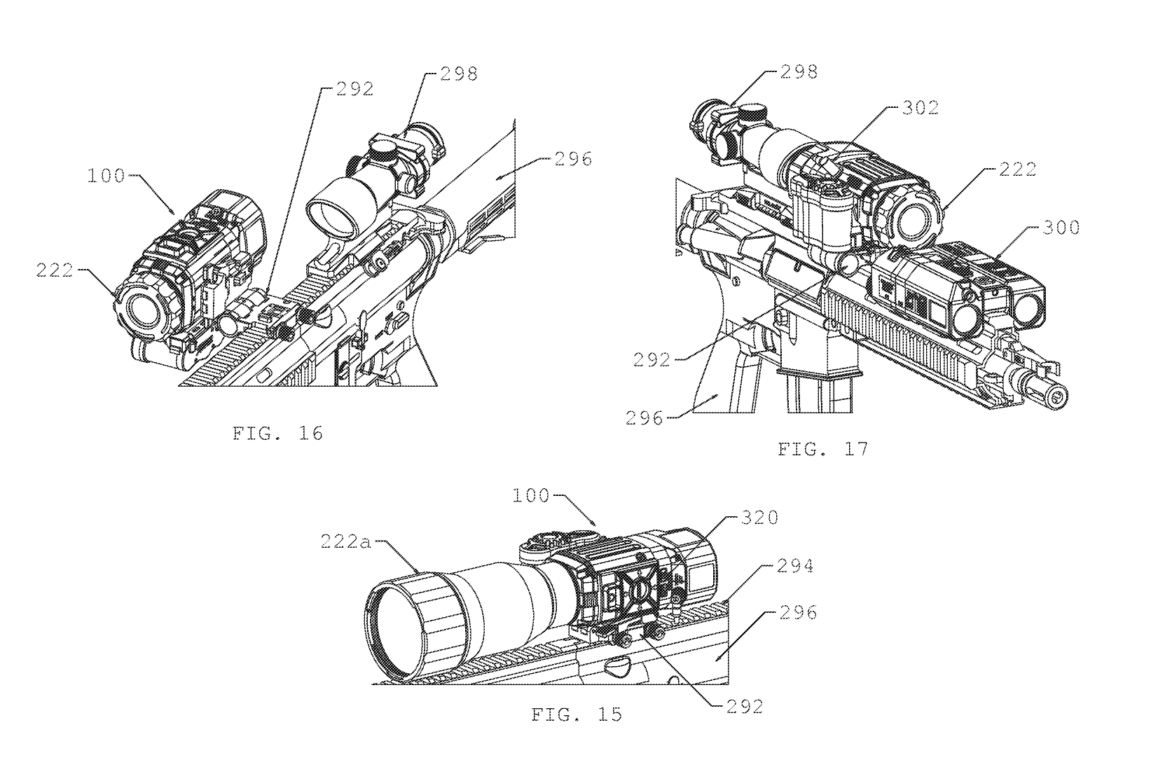

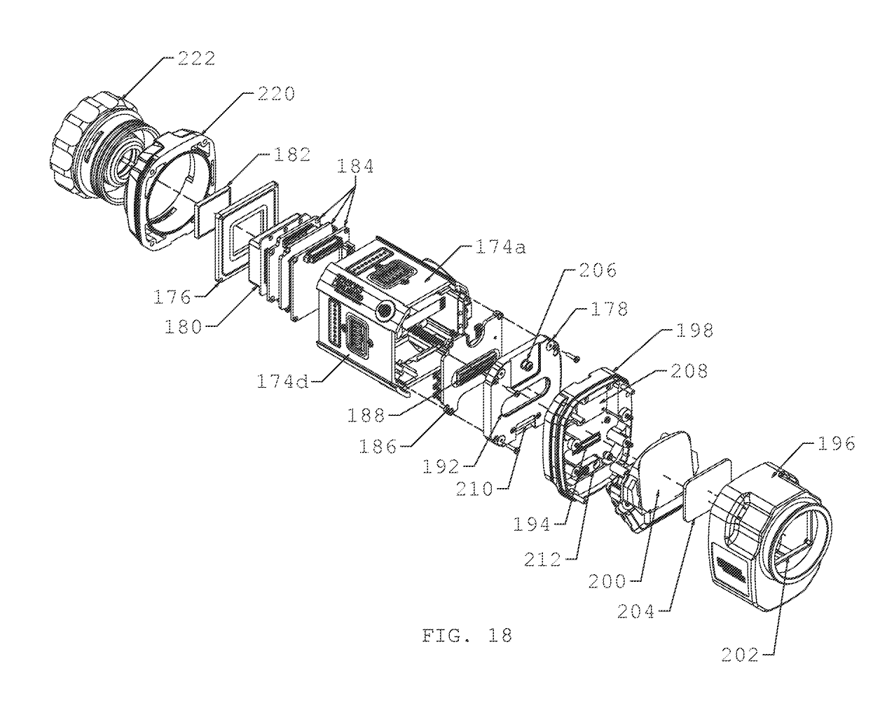

FIG. 4, taken generally from the front and left side.

FIG. 6 is an alternative embodiment camera system configured for hand held use, taken generally from the rear and right side.

FIG. 7 is a top view of the system appearing in FIG. 6, configured for left hand use.

FIG. 8 is a top view of the system appearing in FIGS. 6 and 7, which has been reconfigured for right hand use.

FIG. 9 is an exploded, perspective view of an further exemplary embodiment camera system configured for hand held use and including a laser designator or pointer, taken generally from the front, top, and right side.

FIG. 10 is an exploded, perspective view of a further exemplary embodiment camera system configured for hand held use and including a laser designator or pointer, taken generally from the front, bottom, and right side.

FIG. 11 is an exploded, perspective view of a further exemplary embodiment camera system having interchangeable lenses and a video recorder module.

FIG. 12 is a perspective view of a further exemplary embodiment camera system configured for weapon mounting, taken generally from the rear and right side.

FIG. 13 is a perspective view of the system appearing in FIG. 12, taken generally from the front and the left side.

FIG. 14 is a perspective view of the embodiment appearing in FIG. 13, mounted in front of an optical scope/magnifier.

FIG. 15 is a perspective view of a further exemplary embodiment camera system configured for weapon mounting and video recording, taken generally from the front and right side.

FIG. 16 is a perspective view of the system appearing in FIG. 15, mounted in front of a scope and pivoted to the side.

FIG. 17 is a perspective view of the system appearing in FIG. 15, mounted in front of a scope and used in conjunction with a laser range finder/ballistic computer.

FIG. 18 is an exploded perspective view of the camera body, lens assembly, and display assembly.

### DETAILED DESCRIPTION OF THE PREFERRED EMBODIMENTS

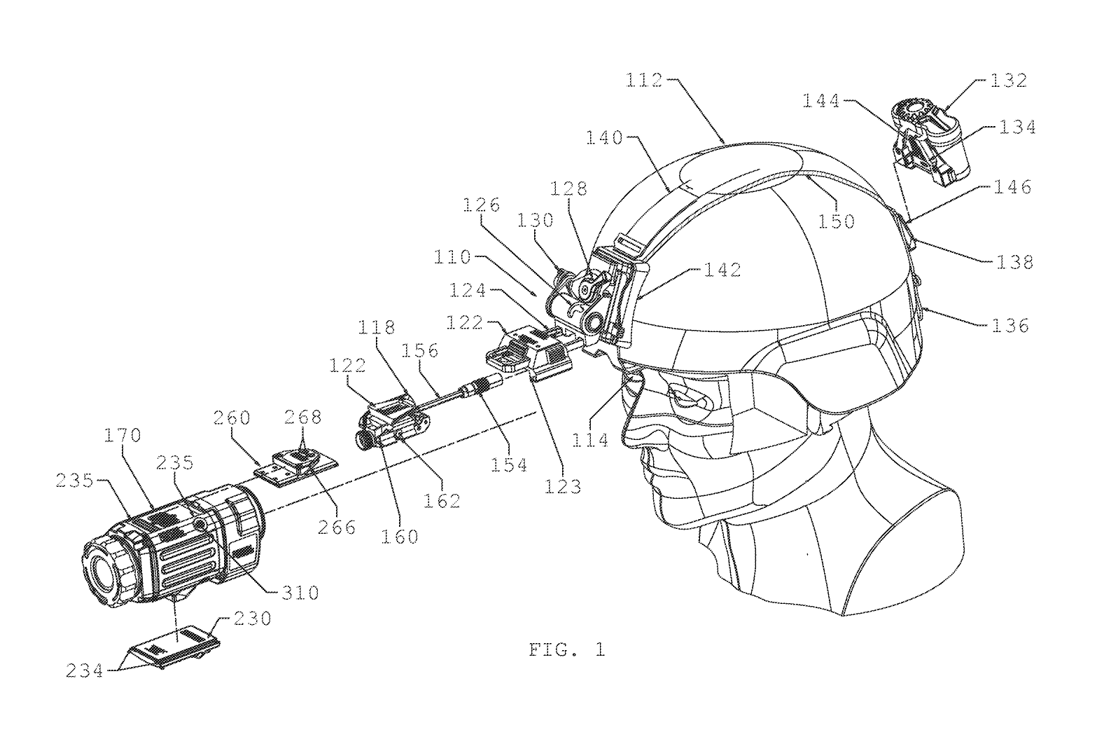

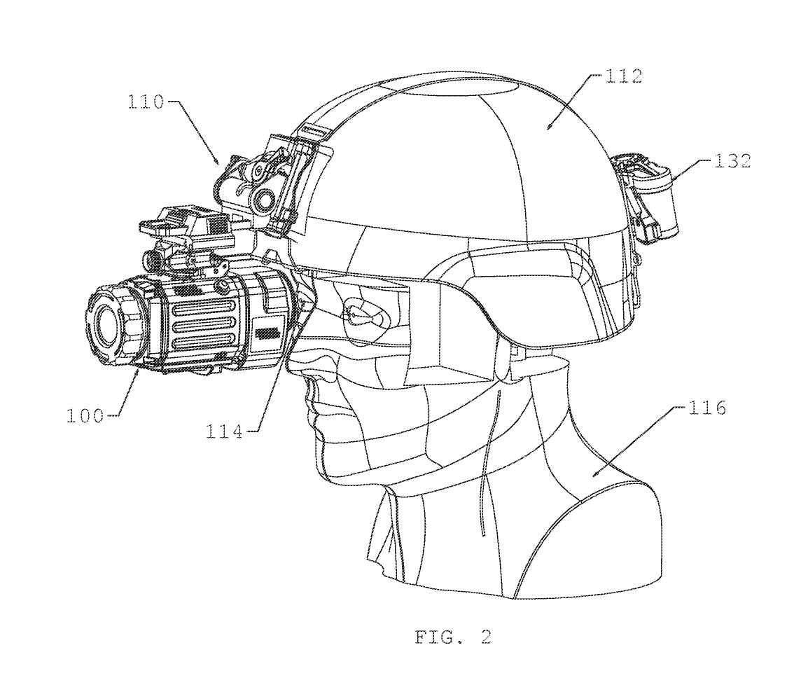

Referring now to the drawings, FIG. 1 depicts an exemplary embodiment modular camera system 100 having a first configuration adapted for use with a helmet mount 110 of a type configured to attach to a helmet 112 or like headgear, to position the camera system 100 in front of an eye 114 of a user 116.

The camera system 100 includes a helmet mount adapter 118, which includes a mounting shoe 120, such as a tapered or dovetail type mounting shoe, for removable attachment to a complementary mount 123 on a sliding carriage 122. Although shown configured for right eye operation, the adapter 118 can also be configured for left-eye operation or for binocular viewing with two camera systems. The adapter 118 may also include a lateral adjustment mechanism 119 for aligning the camera system 100 at a desired transverse position, e.g., in alignment with the pupil of the user's eye 114. The sliding carriage 122 is slidably carried on carriage rails 124, to provide a fore-and-aft adjustment of the camera system 100, i.e., to allow the camera system to be selectively positioned at a desired position, e.g., focal position, along the optical axis of the user's eye 114.

The helmet system 110 also includes a pivot assembly 126 to allow the carriage rails to pivot upward to move the camera system 100 between an operative position in front of the eye of the user when the camera is in use and a stowed position above the user's line of sight when the camera system is not in use. The pivot assembly 126 is also attached to a vertical adjustment assembly 128 to allow the camera system 100 to be moved to a desired vertical position relative to the eye of the user. A tilt adjust mechanism 130 may be provided to allow the optical axis of the camera system 100 to be aligned with the optical axis of the user's eye 114.

A battery pack 132 includes a mount 134 which removably receives a powered shoe 138 on a rear helmet bracket 136. The illustrated rear helmet bracket embodiment includes hooks which engage the rear brim portion of the helmet, although other bracket types are contemplated. A strap 140 may be provided to couple the rear bracket 136 to a front helmet bracket or shroud 142. The shroud 142 provides an interface between the helmet mount 110 and the helmet 112.

Electrical connectors 144 within the mount 134 align with and contact electrical connectors 146 on the shoe 138. Electrical conductors 150 pass over, under, or within the helmet 112 and electrically couple the contacts 146 to an electrical connector 152. The adapter 118 includes an electrical connector 154 which is complementary with the electrical connector 152. A cable 156 provides electrical communication between the connector 154 and contacts 162 on a mounting receptacle 160 on the underside of the adapter 118.

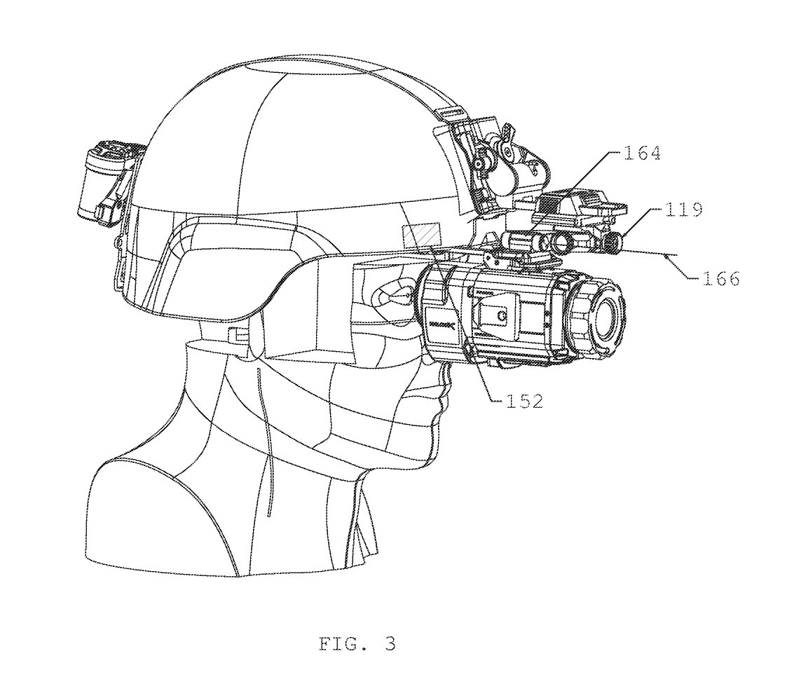

As best seen in FIG. 3, the adapter 118 includes a pivot bridge 164, which allows the camera system 100 to be pivoted about an axially extending pivot axis 166, to move the camera system 100 from a deployed position before the eye of the user and a stowed position wherein the camera system 100 is pivoted up and out of the line of sight of the eye of the user. The stowed position wherein the camera system 100 is pivoted about the pivot axis 166 may be used as an alternative to or in addition to movement of the camera system 100 to a stowed position by pivoting using the transverse pivot assembly 126.

The camera system 100 includes a main camera body 170 comprising a housing shell 172 having four mounting surfaces 174a, 174b, 174c, and 174d. A front end housing piece 176 is attached to the front end of the housing shell 172. A rear end housing plate 178 is attached to the rear end of the housing shell 172.

A photosensor 180 is received within the housing shell 172 and extends or is exposed through an aperture 182 within the front end piece 176. One or more circuit boards 184 are received within the housing shell 172 and are electrically coupled to the sensor 180 and contain a processor or like processing electronics for converting the signal output from the sensor array 180 to an analog or digital video signal. The processing electronics may be implemented in hardware, software, firmware, or a combination thereof and may include a processor having an associated memory configured with executable instructions.

In preferred embodiments, the photosensor 180 is sensitive to IR radiation and in especially preferred embodiments, the photosensor is sensitive to radiation in the short wave infrared (SWIR) region and may be, for example, an indium gallium arsenide (InGaAs) sensor. It will be recognized that the photosensor 180 could be a visible light imaging sensor or a thermal imaging sensor.

A video connector plate 186 is mounted within the housing shell 172 and carries a video connector 188 for outputting a video signal representative of an imaged scene for display in human viewable form using a display assembly 190. The video connector 188 extends through an aperture 192 in the rear end piece 178.

The display assembly 190 is attached to the rear end plate 178. A display video connector 194 is attached to the camera video connector 188. The display assembly 190 includes a housing shell 196 and a rear plate 198. The display assembly 190 includes a display screen 200, such as a liquid crystal display (LCD), cathode ray tube (CRT), light emitting diode (LED) display, or the like. The display screen 200 is viewable through an aperture 202 and transparent, e.g., glass, lens 204.

In the illustrated preferred embodiment, the display assembly 190 is attached to the camera body 170 via a post 206, e.g., a stainless steel post, which is removably received within a complementary receptacle 208 on the back plate 198. In addition, a latch member 210 on the back plate 198 removably engages a complementary catch 212 on the plate 178.

A lens mount 220 is attached to front housing piece 176. The lens mount 220 provides an interface for detachably mounting a lens assembly 222. In preferred embodiment, multiple, interchangeable lens assemblies are provided to allow the user to attach a desired lens assembly, e.g., one having a desired angle of view, aperture size, depth of focus, etc. For example, the lens 222 may be a short range lens which is removable and may be exchanged with a long range lens 222a. The lens mount 220 may be, for example, a bayonet-type mount, as would be understood by those skilled in the art.

The camera system 100 includes a plurality of detachable and interchangeable modules, as described below, each of which can be attached a desired one of the attachment surfaces 174a, 174b, 174c, 174d to provide a customizable camera configuration.

In certain embodiments, a keypad module 230 is provided for controlling operation of the camera system. The keypad module is removably attachable to at least one of the mounting surfaces and is interchangeable with other modules. The keypad module 230 includes a housing 232 having axially extending tongues or slide rails 234 on opposite sides thereof. The slide rails 234 are slidably received in opposing channels or grooves 235 formed on opposite sides of each of the attachment surfaces 174a, 174b, 174c, 174d. The coupling mechanism between the detachable modules (including the keypad module 230 and others) and the camera housing 172 may include additional detachable fasteners, such as latch systems, snap fit systems, or other locking systems.

The keypad module 230 includes a plurality of buttons, e.g., up, down, left, and right arrow buttons 236a-236d and a “menu,” “enter,” or “select” button or the like 236e, which allows the user to navigate an on-screen interface, e.g., a menu-based or other graphical interface, displayed on the display screen 200 for controlling operation of the camera system 100. The keypad module 230 may optionally also include a dedicated power button 238, although in other embodiments, the dedicated power button 238 may be omitted, wherein the camera system 100 can be powered on via any one or more of the buttons 236a-236e (including button press combinations and/or sequences) and the unit 100 can be powered off using the buttons 236a-236e (e.g., using button press combinations or sequences) and/or via a “power off” function available in software via the on-screen interface.

An alternative keypad module 240 appears in FIG. 11 and includes a laser device 242 and actuator buttons 244. The laser device may be a laser designator, e.g., of a type providing guidance for a laser guided weapon, and/or laser pointer, e.g., of a type that provides for pinpointing a specific target or marking a friendly position with a beam which is rendered visible using an appropriate viewing device such as a night vision viewing device. In preferred embodiments, the beam emitted by the laser designator is rendered visible using the camera system in accordance with the present disclosure. Alternatively, the laser designator may be a laser flood device which emits light having a wavelength which improves the imaging capability of the camera system herein and/or other viewing device. The keypad module 240 may be otherwise as described above by way of reference to the keypad module 230.

A separate laser module 250 may also be provided. The laser module 250 includes a housing 252 having axially extending slide rails 254 on opposite sides thereof. The slide rails 254 are slidably received in the opposing channels 237 formed on opposite sides of each of the attachment surfaces 174a, 174b, 174c, 174d. The laser module 250 includes a laser 256 which may emit at a wavelength that is detectable by the sensor 180. In a preferred embodiment, the sensor 180 is a SWIR sensor and the laser 256 emits a beam in the SWIR region. The laser 256 may be a pointer or designator as described above. In alternative embodiments, the laser 256 is a flood illuminator, e.g., visible or IR flood illuminator. In certain embodiments, the laser module 250 may comprise a plurality of coaligned lasers which are individually selectable by the user. In one embodiment, the laser module includes a visible pointing laser, an IR or SWIR pointing laser, and an IR or SWIR illuminator laser.

A powered shoe module 260 includes a housing 262 having axially extending slide rails 264 on opposite sides thereof. The slide rails 264 are slidably received in the opposing channels 237 formed on opposite sides of each of the attachment surfaces 174a, 174b, 174c, 174d. The powered shoe module 260 includes a dovetail mounting shoe 266 having electrical contacts 268 which are electrically coupled to electrical contacts 270 on the respective attachment surface 174a, 174b, 174c, 174d when the powered shoe is attached thereto.

The mounting shoe 266, in turn, is removably attachable to the mounting receptacle 160 on the adapter shoe 118. Alternatively, the mounting shoe 266 may be attached directly to the mounting receptacle 134 on the battery pack 132. The mounting shoe 266 may also be attached to a hand grip member 280. The hand grip member 280 may include a contoured surface 282 to provide a comfortable or ergonomic gripping surface when the camera system 100 is used in a hand-held mode. Advantageously, the handgrip member 280 may include a hand strap 284.

A mechanical (i.e., non-powered) shoe module 290 is also contemplated for mechanically mounting the camera system 100, where a powered connection is not required. For example, a non-powered shoe module 290 could be used to attach a hand grip module 280. The mechanical shoe 290 may include the mechanical structure of the powered shoe module, without the electrical connectors. For example the mechanical shoe module 290 can be used to removably attach the camera system 100 to a rail clamp 292 attached to a weapon accessory rail interface 294, such as a Picatinny type mounting rail structure (e.g., as per standard MIL-STD-1913 or NATO equivalent) or other accessory mounting interface. In this manner, the camera system 100 may be used in connection with a firearm or other weapon 296, e.g., as a sight as shown in FIGS. 12, 13, and 15. Advantageously, the rail clamp 292 is of the pivoting or flip-to-side type, which allows the camera system 100 to be pivoted out of the way (see FIG. 16) when not in use, without the need to remove the unit from the firearm, as shown in FIG. 16.

In certain embodiments, the camera 100 may be positioned on a firearm 296 in front of an optical magnifier 298, such as a 3x, 4x or other power magnifier 298 to provide a magnified view of the display screen 200 to provide targeting through the camera system 100 (see FIG. 14). In operation, the camera system 100 may be pivoted to the side and out of the way when not in use, e.g., allowing the magnifier 298 to be used as a low power scope (see FIG. 16). The thickness dimension of the rail clamp member may be selected to cause the optical axis of the camera system 100 to be positioned at a specified height above the surface of the weapon accessory rail interface 294. In certain embodiments, the height may be selected to align the display screen with the optical magnifier.

In still further embodiments, as shown in FIG. 17, the camera system 100 can be used with a laser range finder unit 300 which may have an on-board ballistic computer or processor. Alternatively, the ballistics computation may be performed by a program of executable instructions residing in the memory of the main camera body. The range finder may be a RAPTAR™ range finder available from Wilcox Industries Corp. of Newington, N.H. In certain embodiments, range data and ballistic computations are sent to the camera module via a data connection 302. In alternative embodiments, range data from a range finder is sent to the camera module and ballistics computations are performed by the processing unit within the camera module 100.

In certain embodiments, the range data and ballistics computation may be used to display an on-screen indicia such as a reticle, cross-hairs, or the like on the display 200 that are superimposed on the imaged scene to facilitate aiming the firearm 296. For example the indicia may positioned at a position on the screen to designate an aiming point which will cause the path of a fired projectile to intersect with the line of sight extending between the user and the desired target, that is to say, wherein the on screen indicia is positioned on the display screen 200 at a position which compensates for the range (ballistic drop) and other ballistics factors.

A video out connector 310 may be provided on the housing shell 172 for outputting a video signal to another display (not shown), such as a weapon mounted video display or other display, an analog or digital video recorder, and so forth. The connector 310 may be a known analog or digital video connector, such as a component video connector, S-video connector, IEEE 1394 connector, VGA connector, digital visual interface (DVI) connector, or the like.

As shown in FIG. 11, an optional recording module 320 may be provided for acquisition and storage of an imaged video scene. The recording module 320 includes an input video connector 322 on the forward facing surface which is aligned with and complementary with the video output connector 188 on the camera body 170. An output video connector 324 is provided on the rearward facing surface 178 of the recording module 320. The connector 320 is aligned with and complementary with the video input connector 194 on the display assembly 190.

In the illustrated embodiment, the recording module 320 is attached to the camera body 170 via the post 206, which is removably received within a complementary receptacle on the recording module 320. In addition, the latch member 210 on the back plate 198 removably engages a complementary catch on the recording module 320.

The recording module 320 is attached to the display assembly 190 via a post 330, e.g., a stainless steel post, which is removably received within the complementary receptacle 208 on the display assembly 190. In addition, a latch member 332 on the recording module 320 removably engages the complementary catch 212 on the display assembly 190.

Power and video signals from the video circuit boards 184 are passed to the recorder unit 320 via the connectors 188 and 194. The video signal is converted to a digital representation via analog-to-digital conversion circuitry 340 in the recorder module 320 and stored on an electronic storage medium 342, which is preferably a removable or swappable storage medium such as a flash memory card or other solid-state electronic data storage device, optical medium, magneto-optical medium, etc. Alternatively, the video signal may be digitized by an analog-to-digital converter in the camera module 170 and transferred to the recording module 320 as digital data for storage on the digital storage medium 342. Recording may be initiated using the record on button 334 and recording may be stopped using the record off button 336. Alternatively or additionally, the recording function could be controlled by control buttons on a keypad module attached to one of the attachment surfaces 174a, 174b, 174c, 174d.

In alternative embodiments, the recording module 320 can be replaced with a wireless communications interface, e.g., configured to transmit data representative of video recorded or imaged by the camera system 100 over a wireless communications network and/or to receive video or other data over a wireless communications network, e.g., for display on the display 200.

The invention has been described with reference to the preferred embodiment. Modifications and alterations will occur to others upon a reading and understanding of the preceding detailed description. It is intended that the invention be construed as including all such modifications and alterations.

What is claimed is:

1. A modular camera system, comprising:
a camera body having a first housing, the first housing having a rearward facing end, a forward facing end opposite the rearward facing end, and a plurality of mounting surfaces extending between the rearward facing end and the forward facing end;
a photosensor mounted on the forward facing end of the camera body;
a lens mount attached to the forward facing end of the camera body for removably attaching a lens assembly configured to direct photons from an area outside the camera body to the photosensor;
a processor within the camera body operably coupled to the photosensor and configured to convert a signal received from the photosensor to a video signal;
a display assembly configured to be removably attached to the rearward facing end of the camera body, the display assembly including a display screen configured to display the video signal received from the processor in human viewable form; and
each of the plurality of mounting surfaces includes one or more fastener elements for removably and interchangeably attaching an accessory module.

2. The modular camera system of claim 1, wherein at least one of said mounting surfaces includes an electrical connector configured to provide an electrical coupling between the camera body and an attached accessory module.

3. The modular camera system of claim 1, wherein the photosensor is sensitive to radiation in the short wave infrared (SWIR) region.

4. The modular camera system of claim 1, wherein the processor includes a digital signal processor for converting the signal received from the photosensor to a digital video signal.

5. The modular camera system of claim 1, further comprising:
said display assembly removably attached to the camera body;
a video connector on the rearward facing end of the camera body mating with an aligned video connector on the display assembly.

6. The modular camera system of claim 1, further comprising a plurality of lens assemblies interchangeably attachable to the lens mount.

7. The modular camera system of claim 1, wherein each of the mounting surfaces includes a pair of opposing axially extending channels, each axially extending channel configured to receive a complementary slide rail on an attached accessory device.

8. The modular camera system of claim 1, further comprising:
a keypad module including a second housing configured to be removably attached to a selected one of said mounting surfaces and a plurality of keys, the keypad module operatively coupled to the camera body for controlling operation of the modular camera system.

9. The modular camera system of claim 8, further comprising:
a laser light source attached to the keypad module, the keypad module including one or more keys for controlling operation of the laser light source.

10. The modular camera system of claim 1, further comprising:
a laser module including a second housing configured to be removably attached to a selected one of said mounting surfaces and one or more laser light sources mounted within the second housing, wherein the laser module is configured to operate as one or more of a laser designator, laser pointer, and a laser illuminator.

11. The modular camera system of claim 10, wherein the photosensor is sensitive to a wavelength corresponding to a wavelength of at least one of said one or more laser light sources.

12. The modular camera system of claim 1, further comprising:
a mounting shoe module having a second housing configured to be removably attached to a selected one of the mounting surfaces; and
a mounting shoe disposed on the second housing.

13. The modular camera system of claim 12, further comprising:
a first set of electrical contacts on the mounting shoe module contacting a second set of electrical contacts on at least one of said mounting surfaces when the mounting module is attached to said at least one of said mounting surfaces; and
a third set of electrical contacts on the mounting shoe electrically coupled to the first set of electrical contacts for electrically coupling the first set of electrical contacts to a power supply.

14. The modular camera system of claim 13, further comprising the power supply module, said power supply having a third housing and one or more electric batteries received within the third housing, the power supply module including a receptacle for removably receiving the mounting shoe and a fourth set of electrical contacts within said receptacle and electrically coupled to said one or more electric batteries.

15. The modular camera system of claim 12, wherein the mounting shoe is a dovetail mounting shoe.

16. The modular camera system of claim 12, further comprising:
a helmet mount adapter having a receptacle for removably receiving the mounting shoe for coupling the camera body to a head worn mounting system.

17. The modular camera system of claim 16, wherein the helmet mount adapter includes a lateral adjustment mechanism for moving the camera body to a desired transverse position.

18. The modular camera system of claim 16, further comprising:
an electrical connector on the helmet mount adapter for electrically coupling the helmet mount adapter to a power supply remotely located power supply.

19. The modular camera system of claim 12, further comprising:
a handgrip module having a first side including a receptacle for removably receiving the mounting shoe and a second side opposite the first side defining a contoured gripping surface for grasping by a user during hand held use of the modular camera system.

20. The modular camera system of claim 12, further comprising:
a rail clamp module having a first fastener and a second fastener;
the first fastener including a receptacle for removably receiving the mounting shoe; and
the second fastener including a rail clamp for removably attaching the rail clamp module to a weapon accessory rail interface.

21. The modular camera system of claim 20, wherein the first fastener is pivotally attached to the second fastener about a pivot axis which extends parallel to an optical axis of the camera body.

22. The modular camera system of claim 20, further comprising an optical magnifier for providing a magnified view of said display screen.

23. The modular camera system of claim 20, further comprising a laser range finder coupled to the camera body, the camera body configured to receive range information, a ballistics computation, or both, from the laser range finder.

24. The modular camera system of claim 23, further comprising:
executable instructions stored in an electronic memory associate with the processor configured to display one or more on-screen indicia on the display, the one or more on-screen indicia being positioned on the display screen to assist a user in aiming an associated weapon at a target.

25. The modular camera system of claim 1, further comprising:
a digital video recording module configured to be removably interposed between the rearward facing end of the camera body and the display assembly;
a first video output connector on the rearward facing surface of the camera body configured to send the video signal to a first input video connector on the digital video recording module; and
an electronic storage medium in the digital video recording module for storing a digital representation of the video signal.

26. The modular camera system of claim 1, further comprising:
a wireless communication module configured to perform one or both of (a) transmitting data representative of the video signal over a wireless communications network and (b) receiving data over the wireless communications network for display on the display screen.
